(19) United States
(12) Patent Application Publication
(10) Pub. No.: US 2006/0114763 A1
(43) Pub. Date: Jun. 1, 2006

(54) Content recording apparatus

(76) Inventors: Nobutaka Nakamae, Takatsuki-shi (JP); Kazuya Nishimura, Joyo-shi (JP)

Correspondence Address: McDERMOTT WILL & EMERY LLP, 600 13th Street, N.W., Washington, DC, 20005-3096, US

(21) Appl. No.: 11/285,776

(22) Filed: Nov. 23, 2005

(30) Foreign Application Priority Data
Nov. 30, 2004 (JP) 2004-347431
Nov. 15, 2005 (JP) 2005-330643

(51) Int. Cl. G11B 17/22

(52) U.S. Cl. 369/30.28

(57) ABSTRACT

In a content recording apparatus, attribute information of first content which is to be recorded to a recording medium is compared with attribute information of second content which has been recorded on the recording medium. As a result of the comparison, if ID information of the first content differs from ID information of the second content, the first content is recorded to the recording medium. If the ID information of the first content is same as the ID information of the second content and the first content has a higher quality than the second content, the first content is recorded to the recording medium to replace the second content. If the ID information of the first content is same as the ID information of the second content and the first content has no higher quality than the second content, the first content is not recorded to the recording medium.

This application is based on an application No. 2004-347431 filed in Japan, the contents of which are hereby incorporated by reference.

### BACKGROUND OF THE INVENTION

1. Field of the Invention

The present invention relates to a content recording apparatus for recording content to a recording medium, and in particular relates to techniques for improving the quality of content recorded on a recording medium.

2. Related Art

Nowadays, electronic devices (e.g. a PC, an AV device, and a portable terminal) having a function of acquiring content (e.g. a TV program, a game, and music) from various media (e.g. a portable optical disc and memory card, and a network) and recording the acquired content to a recording medium such as a hard disk or a memory are widely available.

Through the use of such an electronic device, the user can easily acquire content and record it to a recording medium. Hence content recording tends to be performed frequently. As a result, data which is the same as the one already recorded on the recording medium may end up being recorded again.

To avoid such needless duplication in recording, Japanese Patent Application Publication No. 2004-71062 discloses an information recording/playback apparatus that prevents recording of content which is the same as already-recorded content.

Suppose two songs named “music 1” and “music 2” on an optical disc are requested to be recorded to a hard disk in the information recording/playback apparatus. For each of these songs, the information recording/playback apparatus searches the hard disk for attribute information which shows the name of the song.

If the search reveals that the song “music 1” has already been recorded on the hard disk, the information recording/playback apparatus reads only song data of the song “music 2” from the optical disc and records it to the hard disk, without recording song data of the song “music 1”.

A sound quality of music recorded as digital data varies depending on a compression scheme and a bit rate of the data. This being so, there may be a case where the song data of the song “music 1” on the optical disc has a higher sound quality than song data of the same song “music 1” on the hard disk.

Even when the song data of the song “music 1” on the optical disc has a higher sound quality, however, the above information recording/playback apparatus does not record the song data of the song “music 1” stored on the optical disc to the hard disk if the song “music 1” is already present on the hard disk. Thus, this technique is disadvantageous to the user when the song data on the optical disc has a higher sound quality than the song data on the hard disk.

### SUMMARY OF THE INVENTION

In view of the above problem, a first object of the present invention is to provide a content recording apparatus and its relevant techniques for improving the quality of content recorded on a recording medium while avoiding duplicated recording.

Also, a second object of the present invention is to provide a content recording apparatus and its relevant techniques for, when same content is present on a plurality of recording media, reading highest-quality content from one of the plurality of recording media and recording the highest-quality content to a destination recording medium.

The first object can be achieved by a content recording apparatus including: a first acquisition unit operable to acquire attribute information of first content which is to be recorded to a recording medium; a second acquisition unit operable to acquire attribute information of second content which has been recorded on the recording medium, the attribute information of each of the first content and the second content including ID information of the content and information about a quality of the content; a comparison unit operable to compare the attribute information of the first content with the attribute information of the second content; and a decision unit operable to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

When the content is audio data, the information about the quality of the content shows a compression scheme, a bit rate, a sampling frequency, and the like of the audio data. When the content is image data, the information about the quality of the content shows a compression scheme, a bit rate, a frame size, and the like of the image data. When the content is a computer program, the information about the quality of the content is version information of the computer program.

According to the above construction, if the first content and the second content are judged as the same, higher-quality content is recorded to the recording medium without duplicated recording.

Here, the attribute information may further include information showing a data size of the content, wherein the comparison unit compares a data size of the first content with a data size of the second content, when the ID information of the first content is same as the ID information of the second content and the quality of the first content is equal to the quality of the second content, and the decision unit makes, based on the comparison, the second decision if the ID information of the first content is same as the ID information of the second content, the quality of the first content is equal to the quality of the second content, and the data size of the first content is smaller than the data size of the second content, and the third decision if the ID information of the first content is same as the ID information of the second content, the quality of the first content is equal to the quality of the second content, and the data size of the first content is no smaller than the data size of the second content.

According to the above construction, when the first content and the second content which are judged as the same are equal in quality, smaller-size content is recorded to the recording medium. This contributes to a higher efficiency in the use of the recording medium.

Here, the content recording apparatus may further include a playlist generation unit operable to generate a playlist associated with the first content when the decision unit makes the first decision or the second decision, and a playlist associated with the second content when the decision unit makes the third decision.

Here, the content recording apparatus may further include: a storage unit operable to store a playlist in correspondence with group information showing a group to which content associated with the playlist belongs; and a reception unit operable to receive an indication of the playlist stored in the storage unit, wherein the first acquisition unit acquires the attribute information of the first content based on the group information corresponding to the indicated playlist, and the playlist generation unit updates the indicated playlist to thereby generate the playlist associated with the first content, when the decision unit makes the first decision or the second decision.

According to the above constructions, the newly recorded first content is associated with the indicated playlist. This helps the user know the update.

Here, the content recording apparatus may further include a reception unit operable to receive an input of character information, wherein the first acquisition unit acquires the attribute information of the first content that relates to the received character information.

According to the above construction, only content whose attribute information shows the received character information is recorded to the recording medium. This allows the user to specify all sets of content, which he or she wants to record, at once rather than one at a time, when attribute information of each of these sets of content includes common character information.

Here, the first content may be music including audio data, wherein the content recording apparatus further includes: an obtainment unit operable to obtain the first content when the decision unit makes the first decision or the second decision; an estimation unit operable to analyze the audio data in the first content and estimate a genre of the first content; and a recording unit operable to record the first content to the recording medium, in correspondence with the estimated genre.

According to the above construction, when the attribute information of the first content does not show a genre, the genre is estimated and the first content is recorded in association with the estimated genre.

Here, the attribute information may include, as the ID information, title information showing a name of the content, wherein the decision unit makes (a) the first decision if title information of the first content completely differs from title information of the second content, (b) the second decision if the title information of the first content is partially or completely same as the title information of the second content and the quality of the first content is higher than the quality of the second content, and (c) the third decision if the title information of the first content is partially or completely same as the title information of the second content and the quality of the first content is no higher than the quality of the second content.

According to the above construction, the title information is used to ease the comparison on the sameness of the first content and the second content.

Here, the content recording apparatus may further include a check unit operable to check whether data of the second content is indefective, when the ID information of the first content is same as the ID information of the second content, wherein the decision unit makes the second decision if a result of the check is negative.

According to the above construction, if the data of the second content has a defect, the data of the first content is recorded to replace data of the second content, with it being possible to improve the quality of content on the recording medium.

Here, the check unit may check whether information included in a header of binary data of the second content is correct, when the ID information of the first content is same as the ID information of the second content.

According to the above construction, if the header of the binary data of the second content has a defect, the binary data of the first content is recorded to replace binary data of the second content, with it being possible to improve the quality of content on the recording medium.

Here, the content recording apparatus may further include a check unit operable to check whether a physical address of the second content on the recording medium is correct, when the ID information of the first content is same as the ID information of the second content, wherein the decision unit makes the second decision if a result of the check is negative.

According to the above construction, if the physical address of the second content on the recording medium is incorrect, the first content is recorded at a different physical address, with it being possible to improve the quality of content on the recording medium.

Here, the content recording apparatus may further include a reception unit operable to receive an indication of filter information for selecting the first content, the filter information showing a part of the attribute information of the first content, wherein the first acquisition unit acquires the attribute information of the first content, the attribute information of the first content including the part shown by the indicated filter information.

Here, the content recording apparatus may further include a reception unit operable to receive an indication of filter information for selecting the first content, the filter information showing no part of the attribute information of the first content, wherein the first acquisition unit acquires the attribute information of the first content, the attribute information of the first content including no part shown by the indicated filter information.

According to the above constructions, sets of content whose attribute information includes common information can be specified at once rather than one at a time.

The second object can be achieved by a content recording apparatus including: a reception unit operable to receive a request to record first content which has been recorded on a first recording medium, to a second recording medium; a first acquisition unit operable to acquire attribute information of the first content; a second acquisition unit operable to acquire attribute information of second content which has been recorded on a third recording medium, the attribute information of each of the first content and the second content including ID information of the content and information about a quality of the content; a comparison unit operable to compare the attribute information of the first content with the attribute information of the second content; and a decision unit operable to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.

According to the above construction, if the first content on the first recording medium and the second content on the third recording medium are judged as the same, higher-quality content is recorded to the second recording medium.

Here, the comparison unit may further compare a speed of reading the first content from the first recording medium with a speed of reading the second content from the third recording medium, when the ID information of the first content is same as the ID information of the second content and the quality of the first content is equal to the quality of the second content, wherein the decision unit makes, based on the comparison, (a) the first decision if the ID information of the first content is same as the ID information of the second content, the quality of the first content is equal to the quality of the second content, and the speed of reading the first content is higher than the speed of reading the second content, and (b) the second decision if the ID information of the first content is same as the ID information of the second content, the quality of the first content is equal to the quality of the second content, and the speed of reading the first content is no higher than the speed of reading the second content.

According to the above construction, if the first content and the second content which are judged as the same are equal in quality, content that can be read faster is recorded to the second recording medium, with it being possible to reduce a recording time.

The first object can also be achieved by a content recording method for use in a content recording apparatus, including steps of: acquiring attribute information of first content which is to be recorded to a recording medium; acquiring attribute information of second content which has been recorded on the recording medium, the attribute information of each of the first content and the second content including ID information of the content and information about a quality of the content; comparing the attribute information of the first content with the attribute information of the second content; making, based on the comparison, a first decision to record the first content to the recording medium if ID information of the first content differs from ID information of the second content; making, based on the comparison, a second decision to record the first content to the recording medium to replace the second content if the ID information of the first content is same as the ID information of the second content and a quality of the first content is higher than a quality of the second content; and making, based on the comparison, a third decision not to record the first content to the recording medium if the ID information of the first content is same as the ID information of the second content and the quality of the first content is no higher than the quality of the second content.

The first object can also be achieved by a computer program used in a computer for deciding whether to record content to a recording medium, including: program code operable to cause the computer to acquire attribute information of first content which is to be recorded to the recording medium; program code operable to cause the computer to acquire attribute information of second content which has been recorded on the recording medium, the attribute information of each of the first content and the second content including ID information of the content and information about a quality of the content; program code operable to cause the computer to compare the attribute information of the first content with the attribute information of the second content; and program code operable to cause the computer to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

The first object can also be achieved by a storage medium storing a computer program used in a computer for deciding whether to record content to a recording medium, the computer program including: program code operable to cause the computer to acquire attribute information of first content which is to be recorded to the recording medium; program code operable to cause the computer to acquire attribute information of second content which has been recorded on the recording medium, the attribute information of each of the first content and the second content including ID information of the content and information about a quality of the content; program code operable to cause the computer to compare the attribute information of the first content with the attribute information of the second content; and program code operable to cause the computer to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

The second object can also be achieved by a content recording method for use in a content recording apparatus, including steps of: receiving a request to record first content which has been recorded on a first recording medium, to a second recording medium; acquiring attribute information of the first content; acquiring attribute information of second content which has been recorded on a third recording medium, the attribute information of each of the first content and the second content including ID information of the content and information about a quality of the content; comparing the attribute information of the first content with the attribute information of the second content; making, based on the comparison, a first decision to record the first content to the second recording medium if ID information of the first content differs from ID information of the second content or if the ID information of the first content is same as the ID information of the second content and a quality of the first content is higher than a quality of the second content; and making, based on the comparison, a second decision to record the second content to the second recording medium if the ID information of the first content is same as the ID information of the second content and the quality of the first content is no higher than the quality of the second content.

The second object can also be achieved by a computer program used in a computer for recording content to a recording medium, including: program code operable to cause the computer to receive a request to record first content which has been recorded on a first recording medium, to a second recording medium; program code operable to cause the computer to acquire attribute information of the first content; program code operable to cause the computer to acquire attribute information of second content which has been recorded on a third recording medium, the attribute information of each of the first content and the second content including ID information of the content and information about a quality of the content; program code operable to cause the computer to compare the attribute information of the first content with the attribute information of the second content; and program code operable to cause the computer to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.

The second object can also be achieved by a storage medium storing a computer program used in a computer for recording content to a recording medium, the computer program including: program code operable to cause the computer to receive a request to record first content which has been recorded on a first recording medium, to a second recording medium; program code operable to cause the computer to acquire attribute information of the first content; program code operable to cause the computer to acquire attribute information of second content which has been recorded on a third recording medium, the attribute information of each of the first content and the second content including ID information of the content and information about a quality of the content; program code operable to cause the computer to compare the attribute information of the first content with the attribute information of the second content; and program code operable to cause the computer to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows a functional construction of a content recording/playback apparatus according to an embodiment of the present invention;

FIG. 2 is a flowchart of a duplicated recording prevention operation in the embodiment;

FIG. 3 partially shows attribute information of each specified song on an optical disc and attribute information of each song on a hard disk shown in FIG. 1;

FIG. 4 shows a sound quality comparison chart;

FIG. 5 is a flowchart of an operation of the content recording/playback apparatus shown in FIG. 1, according to modification 1;

FIG. 6 is a flowchart of an operation of the content recording/playback apparatus shown in FIG. 1, according to modification 2;

FIG. 7 shows an example GUI screen displayed on a display device equipped with a speaker shown in FIG. 1;

FIG. 8 partially shows attribute information of each song on the optical disc and attribute information of each song on the hard disk;

FIG. 9 shows an example playlist;

FIG. 10 is a flowchart of an operation of the content recording/playback apparatus shown in FIG. 1, according to modification 3;

FIG. 11 is a flowchart of an operation of the content recording/playback apparatus shown in FIG. 1, according to modification 4;

FIG. 12 shows a functional construction of a content recording/playback apparatus according to modification 5;

FIG. 13 is a flowchart of an operation of the content recording/playback apparatus shown in FIG. 12, according to modification 5;

FIG. 14 is a flowchart of an operation of the content recording/playback apparatus shown in FIG. 12, according to modification 6;

FIG. 15 is a flowchart of an operation of the content recording/playback apparatus shown in FIG. 1, according to modification 7;

FIG. 16 partially shows attribute information of each specified song on the optical disc and attribute information of each song on the hard disk;

FIG. 17 is a flowchart of an operation of the content recording/playback apparatus shown in FIG. 1, according to modification 8;

FIG. 18 is a flowchart of an operation of the content recording/playback apparatus shown in FIG. 1, according to modification 9;

FIG. 19 partially shows attribute information of each specified song on the optical disc and attribute information of each song on the hard disk;

FIG. 20 partially shows attribute information of each specified song on the optical disc and attribute information of each song on the hard disk;

FIG. 21 partially shows attribute information of each song on the hard disk, after a song has been recorded from the optical disc to the hard disk;

FIG. 22 is a flowchart of an operation of the content recording/playback apparatus shown in FIG. 1, according to modification 11;

FIG. 23 shows an example of filter information; and

FIG. 24 partially shows attribute information of each song on the optical disc, and attribute information of each song extracted using different filters.

### DESCRIPTION OF THE PREFERRED EMBODIMENT(S)

The following describes an embodiment of the present invention with reference to drawings.

<Construction>

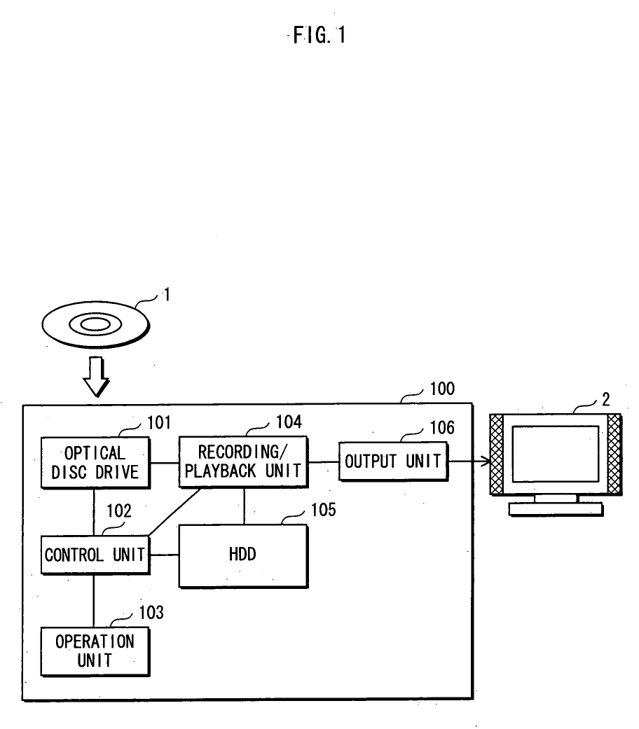

FIG. 1 shows a functional construction of a content recording/playback apparatus according to the embodiment of the present invention.

In the drawing, a content recording/playback apparatus 100 includes an optical disc drive 101, a control unit 102, an operation unit 103, a recording/playback unit 104, a hard disk drive (HDD) 105, and an output unit 106.

The content recording/playback apparatus 100 has a playback function of playing back content recorded on an optical disc 1 and content recorded on a hard disk (HD), and a recording function of reading content data from the optical disc 1 and recording it to the hard disk. The content recording/playback apparatus 100 has a same hardware construction as a general computer, provided with a CPU, a memory, and the like.

The content recording/playback apparatus 100 is connected to a display device 2 having a speaker via a cable, to which images and sounds are to be output.

The optical disc drive 101 has a loading mechanism of loading the optical disc 1, a pickup mechanism of optically reading data recorded on the optical disc 1, a spindle motor for rotating the optical disc 1, and a servo circuit for servocontrolling the spindle motor and the pickup mechanism. The optical disc drive 101 reads data from the loaded optical disc 1, in accordance with control by the control unit 102.

The optical disc 1 is, for example, a CD (Compact Disc) or a DVD (Digital Versatile Disc). A plurality of songs are recorded on the optical disc 1 in a compressed state.

Each song recorded on the optical disc 1 is made up of song data generated by digitizing an audio signal and compressing it according to a predetermined compression scheme, and attribute information (such as a song name, an artist name, an album name, a genre, a compression scheme, a bit rate, a data size, and date and time information).

Having read song data and attribute information of a song from the optical disc 1, the optical disc drive 101 outputs the song data to the recording/playback unit 104, and the attribute information to the control unit 102.

The control unit 102 has a function of controlling each of the other functional units in the content recording/playback apparatus 100, and a function of generating data for a GUI (Graphical User Interface) displayed on the display device 2. The control unit 102 is actually realized by the CPU executing a control program stored on the memory or the hard disk.

The operation unit 103 includes operation buttons, and has a function of receiving various requests (e.g. a specification of a song to be recorded) corresponding to user operations performed on the operation buttons. The operation unit 103 outputs a received request to the control unit 102.

The recording/playback unit 104 has a function of decoding song data received from the optical disc drive 101 or the HDD 105 and playing the decoded song data. The recording/playback unit 104 also has a function of outputting song data received from the optical disc drive 101 to the HDD 105 either directly or having converted it according to a predetermined compression scheme, in order to record the song data to the hard disk.

The recording/playback unit 104 sends the played song data to the output unit 106.

The HDD 105 includes the hard disk having a large-capacity storage area, and has a function of writing/reading data to/from the hard disk in accordance with control by the control unit 102.

The output unit 106 has a function of performing D/A conversion and signal amplification on data such as song data received from the recording/playback unit 104 and GUI data which is image data received from the control unit 102 and outputting resultant analog audio and image signals to the display device 2, in accordance with control by the control unit 102.

The display device 2 has a function of outputting sounds and displaying images, based on the audio signal and the image signal received from the output unit 106.

<Operation>

The following describes an operation of the content recording/playback apparatus 100.

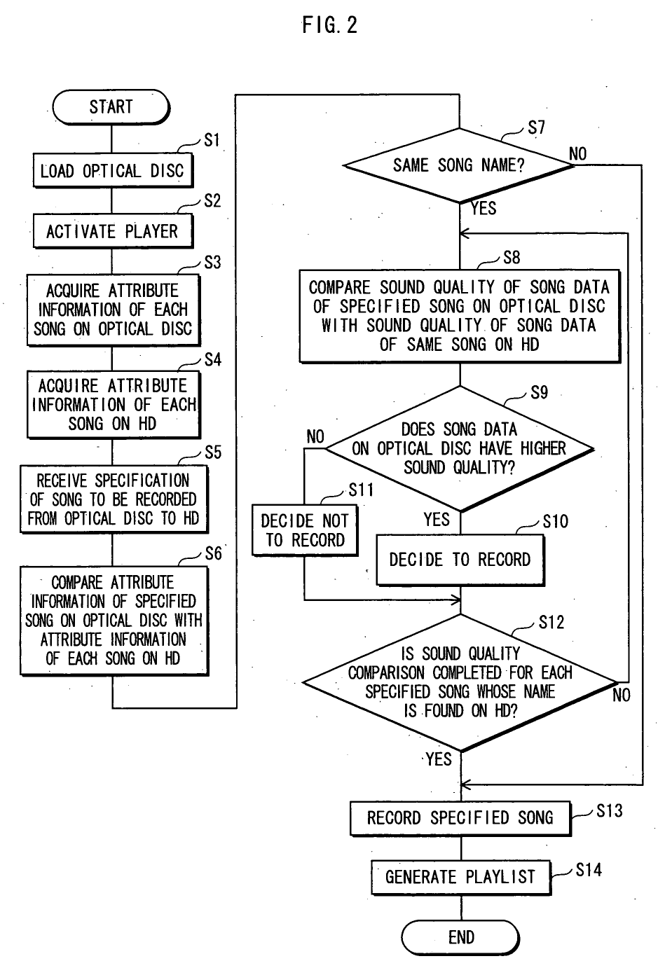

FIG. 2 is a flowchart showing a duplicated recording prevention operation of the content recording/playback apparatus 100 for deciding whether to record a song from the optical disc 1 to the hard disk.

First, the user loads the optical disc 1 to the optical disc drive 101. Upon the loading of the optical disc 1, the optical disc drive 101 notifies the control unit 102 that the optical disc 1 has been loaded (S1).

Having received the notification, the control unit 102 executes an application program (hereafter referred to as a “player”) for recording or playing content (S2), and has the optical disc drive 101 read attribute information of each song recorded on the optical disc 1. The optical disc drive 101 reads the attribute information of each song recorded on the optical disc 1, and sends the read attribute information to the control unit 102 (S3).

The control unit 102 also has the HDD 105 read attribute information of each song recorded on the hard disk. The HDD 105 reads the attribute information of each song recorded on the hard disk, and sends the read attribute information to the control unit 102 (S4).

The control unit 102 stores the attribute information received from the optical disc drive 101 and the HDD 105, to the memory.

The control unit 102 generates GUI data for receiving a content recording request or a content playback request from the user, through the execution of the player. The control unit 102 sends the GUI data to the output unit 106, which outputs the GUI data to the display device 2. As a result, a GUI screen is displayed on the display device 2.

Here, the GUI data includes playlists that are generated based on the attribute information stored on the memory, i.e. the attribute information of each song on the optical disc 1 and the attribute information of each song on the hard disk.

A playlist is a list of songs defined according to artist, album, user preference, or the like. A serial number is assigned to each song in the playlist. The playlist's uses include playing the songs in sequence, and receiving a selection of a song to be played back or to be recorded to another recording medium from the user.

The GUI screen displayed on the display device 2 includes a playlist of the songs recorded on the optical disc 1. The user specifies a song to be played back or to be recorded to the hard disk, in this playlist (S5).

In detail, the user moves a pointer on the screen of the display device 2 and selects a desired song in the playlist, by operating the operation buttons in the operation unit 103.

When receiving a specification of one or more songs to be recorded to the hard disk from the user, the control unit 102 launches the duplicated recording prevention operation.

First, the control unit 102 compares, for each specified song, attribute information of the specified song with attribute information of each song on the hard disk (S6).

If the comparison reveals that a song having the same name as the specified song is present on the hard disk (S7:YES), the control unit 102 compares a sound quality of song data (hereafter “first song data”) of the song on the optical disc 1 and song data (hereafter “second song data”) of the same song on the hard disk (S8). The sound quality referred to here includes a recording method and a bit rate.

If the first song data has a higher sound quality than the second song data (S9:YES), the control unit 102 decides to record the first song data to the hard disk to replace the second song data (S10). The control unit 102 then proceeds to step S12.

If a song having the same name as the specified song is not present on the hard disk (S7:NO), the control unit 102 proceeds to step S13.

If the sound quality of the first song data is equal to or lower than the sound quality of the second song data (S9:NO), the control unit 102 decides not to record the first song data to the hard disk (S11). The control unit 102 then proceeds to step S12.

When the sound quality comparison has been completed for each specified song whose name is found on the hard disk (S12:YES), the control unit 102 proceeds to step S13. If the sound quality comparison has not been completed for each specified song whose name is found on the hard disk (S12:NO), the control unit 102 returns to step S8.

Depending on the decision, the control unit 102 has the optical disc drive 101 read song data to be recorded from the optical disc 1, and has the HDD 105 record the read song data to the hard disk (S13).

Having recorded the song data, the control unit 102 generates a playlist of the songs specified by the user (S14).

Here, regarding a song that was not recorded because the same song is present on the hard disk and second song data of the song on the hard disk has a higher sound quality than first song data of the song on the optical disc 1, the control unit 102 associates the second song data with the playlist.

After this, upon receiving a player end request from the user, the control unit 102 ends the duplicated recording prevention operation.

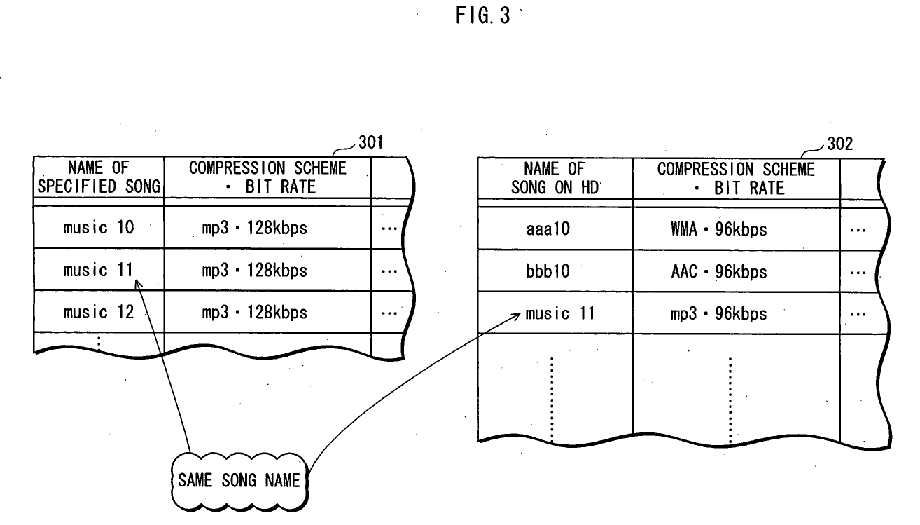

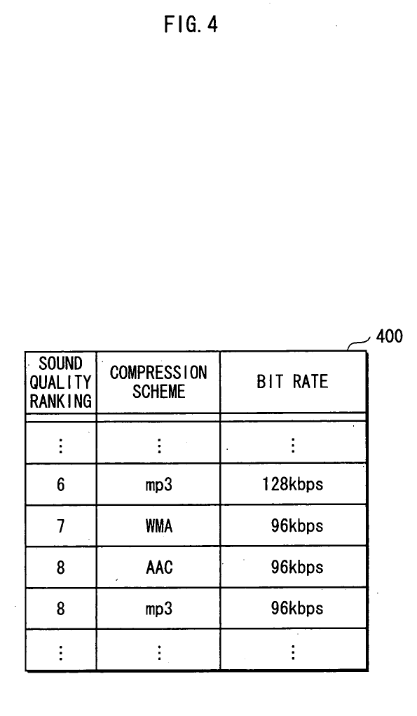

A specific example of the duplicated recording prevention operation is explained below, with reference to FIGS. 3 and 4.

In FIG. 3, a table 301 shows part of attribute information of each song specified by the user from among the songs recorded on the optical disc 1, whereas a table 302 shows part of attribute information of each song recorded on the hard disk.

For each specified song, the control unit 102 compares attribute information of the specified song with attribute information of each song on the hard disk. The comparison reveals that a song “music 11” has already been recorded on the hard disk. The control unit 102 then compares a compression scheme and a bit rate of first song data of the song “music 11” on the optical disc 1, with a compression scheme and a bit rate of second song data of the song “music 11” on the hard disk.

Here, the first song data of the song “music 11” on the optical disc 1 has been recorded according to mp3 (MPEG-1 Audio Layer 3) at a bit rate of 128 kbps.

Meanwhile, the second song data of the song “music 11” on the hard disk has been recorded according to the same mp3 but at a bit rate of 96 kbps.

FIG. 4 shows a sound quality comparison chart 400 used by the control unit 102 for sound quality comparison.

In the sound quality comparison chart 400, a combination of a compression scheme and a bit rate with a higher ranking (a smaller number) has a higher sound quality.

According to this sound quality comparison chart 400, the combination of the compression scheme mp3 and the bit rate 128 kbps is ranked number 6, and the combination of the compression scheme mp3 and the bit rate 96 kbps is ranked number 8. Therefore, the first song data of the song “music 11” on the optical disc 1 has a higher sound quality than the second song data of the song “music 11” on the hard disk.

Note here that in the sound quality comparison chart 400, WMA (Windows Media Audio) denotes an audio compression format developed by Microsoft Corporation, and AAC (Advanced Audio Coding) denotes an audio compression format used in the video compression standards MPEG-2 and MPEG-4.

As described above, upon receiving a specification of a song to be recorded from the optical disc 1 to the hard disk from the user, the content recording/playback apparatus 100 checks whether the same song has already been recorded on the hard disk. If the same song has already been recorded on the hard disk, the content recording/playback apparatus 100 judges whether song data of the song on the optical disc 1 has a higher sound quality than song data of the same song on the hard disk. The content recording/playback apparatus 100 records the song data on the optical disc 1 to the hard disk to replace the already-recorded song data if the song data on the optical disc 1 has a higher sound quality, and does not perform the recording if the song data on the optical disc 1 has no higher sound quality. In this way, higher-quality song data can be recorded on the hard disk without duplicated recording.

<Modification 1>

The above embodiment describes the case where the control unit 102 decides not to record the first song data to the hard disk if the sound quality of the first song data is equal to the sound quality of the second song data in step S9 of the duplicated recording prevention operation, but this may be modified as follows.

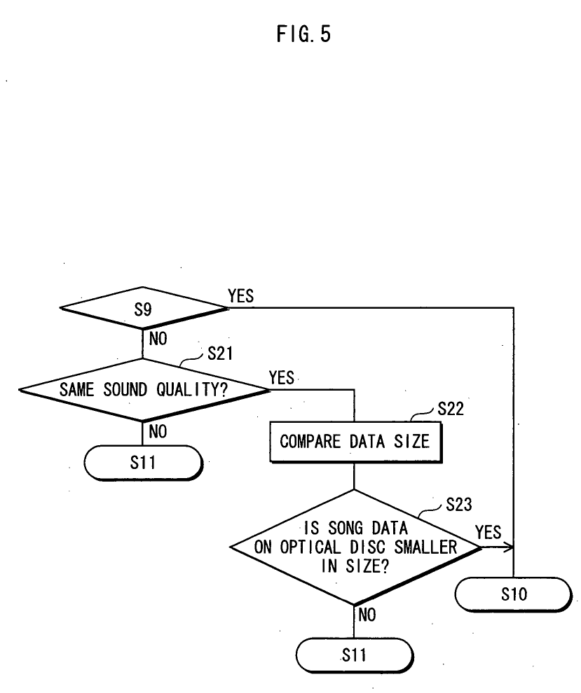

FIG. 5 is a flowchart of an operation of the content recording/playback apparatus 100 according to modification 1.

In this operation, steps S1 to S9 are the same as those shown in FIG. 2, and so their explanation has been omitted here.

The control unit 102 judges whether the first song data has an equal sound quality to the second song data, through the comparison of the attribute information (S21). If the first song data has an equal sound quality to the second song data (S21:YES), the control unit 102 compares a data size of the first song data with a data size of the second song data (S22).

If the first song data has a smaller data size than the second song data (S23:YES), the control unit 102 proceeds to step S10. That is, the control unit 102 decides to record the first song data to the hard disk to replace the second song data.

If the first song data has a lower sound quality than the second song data (S21:NO), the control unit 102 proceeds to step S11. That is, the control unit 102 decides not to record the first song data to the hard disk.

Also, if the first song data has no smaller data size than the second song data (S23:NO), the control unit 102 proceeds to step S11.

Suppose the compression scheme and the bit rate of the first song data are respectively AAC and 96 kbps, and the compression scheme and the bit rate of the second song data are respectively mp3 and 96 kbps. Though the first song data and the second song data are equal in sound quality as shown in FIG. 4, the first song data is smaller in data size than the second song data because AAC has a better compression efficiency than mp3.

According to modification 1 described above, higher-quality and smaller-size song data can be recorded on the hard disk without duplicated recording.

<Modification 2>

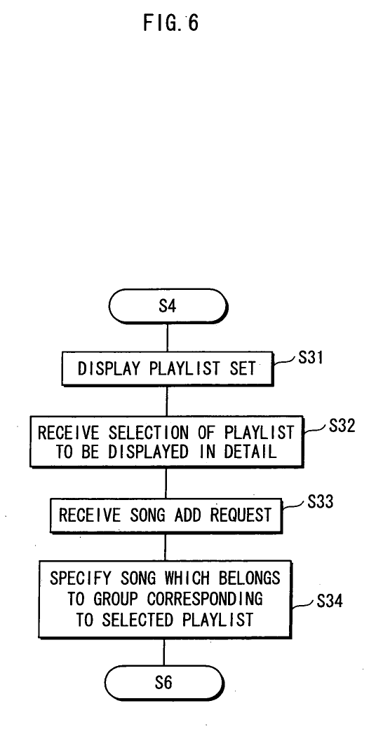

FIG. 6 is a flowchart of an operation of the content recording/playback apparatus 100 according to modification 2.

In this operation, steps S1 to S4 are the same as those shown in FIG. 2, and so their explanation has been omitted here.

After the activation of the player, the control unit 102 generates GUI data showing a set of playlists of the songs recorded on the hard disk.

The control unit 102 sends the generated GUI data to the output unit 106, which outputs the GUI data as an image. As a result, a GUI screen is displayed on the display device 2 (S31).

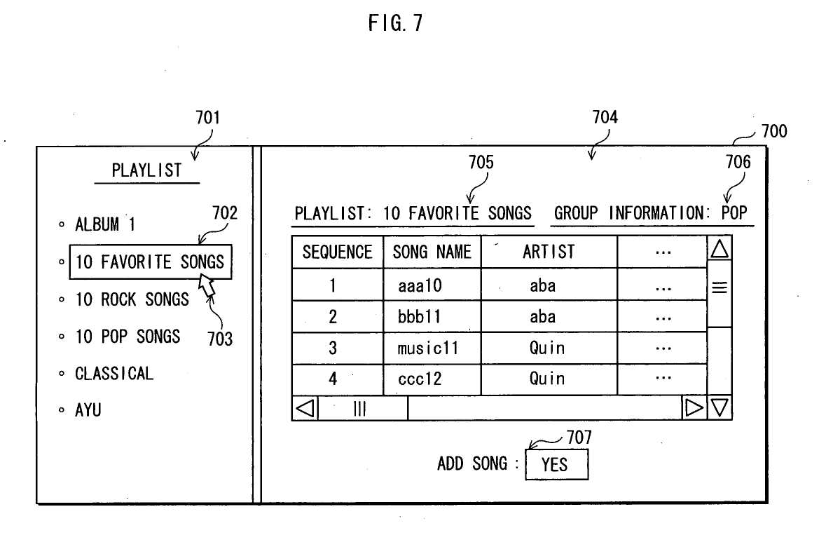

FIG. 7 shows an example GUI screen displayed on the display device 2.

In the drawing, a GUI screen 700 includes a display section 701 showing the playlist set and a display section 704 showing details of a playlist selected from the playlist set.

When the user moves a pointer 703 and selects one playlist in the playlist set by operating the operation buttons in the operation unit 103 (S32), the control unit 102 generates GUI data showing details of the selected playlist and content in the selected playlist, such as a list of attribute information of each song in the selected playlist. The control unit 102 displays the GUI data on the display section 704.

In the example of FIG. 7, the user selects a playlist 702 “10 favorite songs”. Accordingly, a playlist name 705 “10 favorite songs” of the selected playlist, group information 706 “POP” corresponding to the selected playlist, a list of attribute information of each song in the selected playlist, and a GUI button 707 for receiving a request to add a song of the same group to the playlist are displayed in the display section 704.

Here, the group information may indicate a genre, an artist, an album, a recording date, or the like.

In the example of FIG. 7, the group information corresponding to the playlist “10 favorite songs” indicates the genre “POP”, i.e. pop music.

When the user presses the GUI button 707 (S33), the control unit 102 specifies each song which belongs to the same group as the selected playlist from among the songs recorded on the optical disc 1, as a song to be recorded (S34). The control unit 102 then proceeds to step S6.

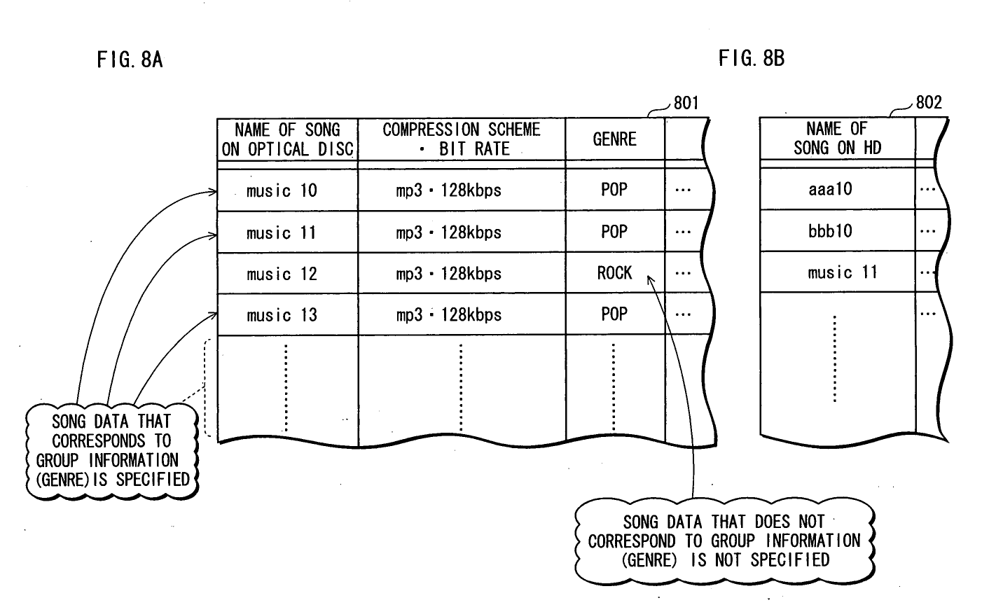

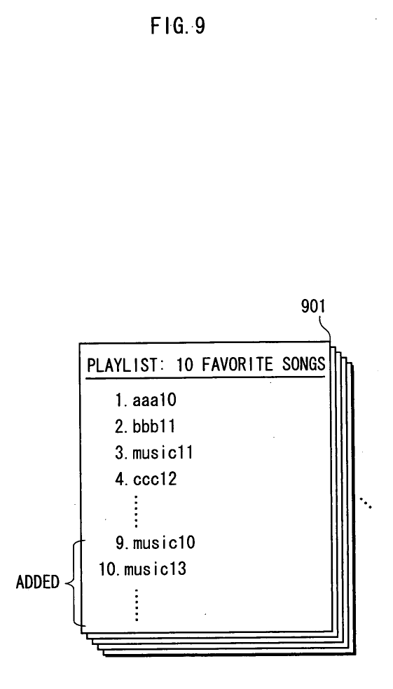

A specific example of this operation is explained below, by referring to FIGS. 8 and 9.

A table 801 in FIG. 8A shows part of attribute information of each song recorded on the optical disc 1, whereas a table 802 in FIG. 8B shows part of attribute information of each song recorded on the hard disk.

When the group information corresponding to the playlist selected by the user indicates “POP”, the control unit 102 specifies each song whose attribute information shows the genre “POP”, from among the songs recorded on the optical disc 1.

In FIG. 8A, a genre of a song “music 12” is “ROCK”, so that the song “music 12” is unspecified.

FIG. 9 shows a playlist 901 “10 favorite songs” to which songs specified in step S34 have been added.

The song add function of modification 2 described above makes it possible to easily add songs that belong to the same group as a playlist, to that playlist.

<Modification 3>

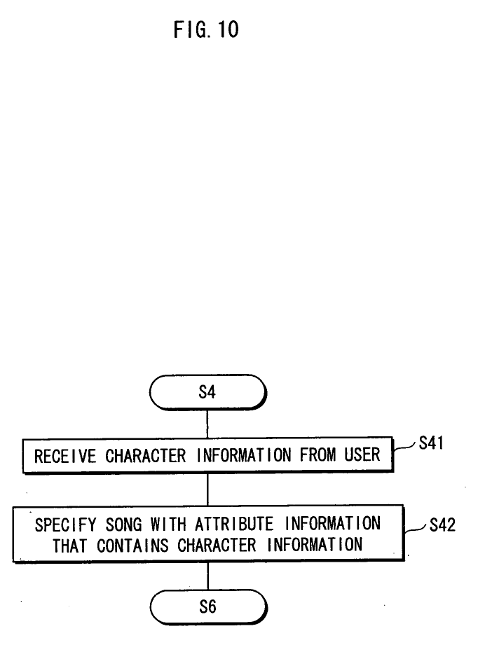

FIG. 10 is a flowchart of an operation of the content recording/playback apparatus 100 according to modification 3.

In this operation, steps S1 to S4 are the same as those shown in FIG. 2, and so their explanation has been omitted here.

After the activation of the player, the control unit 102 generates GUI data for receiving an input of character information from the user.

The control unit 102 sends the generated GUI data to the output unit 106, which outputs the GUI data as an image. As a result, a GUI screen for receiving an input of character information is displayed on the display device 2. When the user inputs character information by operating the operation buttons in the operation unit 103 (S41), the control unit 102 specifies each song whose attribute information contains the input character information, as a song to be recorded (S42). The control unit 102 then proceeds to step S6.

A specific example of this operation is explained below, using the table 801 shown in FIG. 8A.

Suppose the user inputs a character string “ROCK” on the GUI screen displayed on the display device 2. Upon receiving this input, the control unit 102 specifies each song whose attribute information shows “ROCK”, from among the songs on the optical disc 1. Since the attribute information of the song “music 12” shows the genre “ROCK”, the song “music 12” is specified as a song to be recorded.

According to the song selection method of modification 3 described above, it is possible to select only songs that correspond to character information input by the user. This method eases selection of desired songs from an optical disc which stores a large number of songs.

<Modification 4>

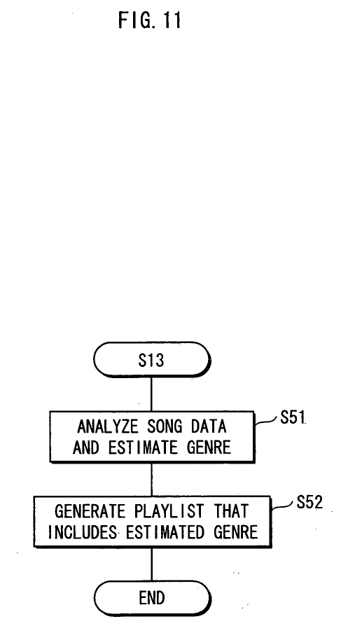

FIG. 11 is a flowchart of an operation of the content recording/playback apparatus 100 according to modification 4.

In this operation, steps S1 to S13 are the same as those shown in FIG. 2, and so their explanation has been omitted here.

The control unit 102 analyzes the recorded song data to estimate a genre of the song (S51). For example, statistical analysis employed in a music selection interface technology called “Music Sommelier”, developed by Matsushita Electric Industrial Co., Ltd. can be used for this song data analysis.

In more detail, an audio signal (waveform) of about 10 seconds at a start of the song is analyzed according to eight parameters such as tempo, beat, and average number of sounds, to extract data called “musical feature quantity”. A genre associated with the extracted musical feature quantity is estimated to be the genre of the song. The attribute information of the song to which the estimated genre has been added is then stored on the hard disk. The control unit 102 generates a playlist including this attribute information (S52).

According to modification 4 described above, even when attribute information of a song to be recorded does not show a genre, the content recording/playback apparatus 100 can estimate the genre and add genre information to the attribute information of the song.

<Modification 5>

The following describes a content recording/playback apparatus to which modification 5 relates.

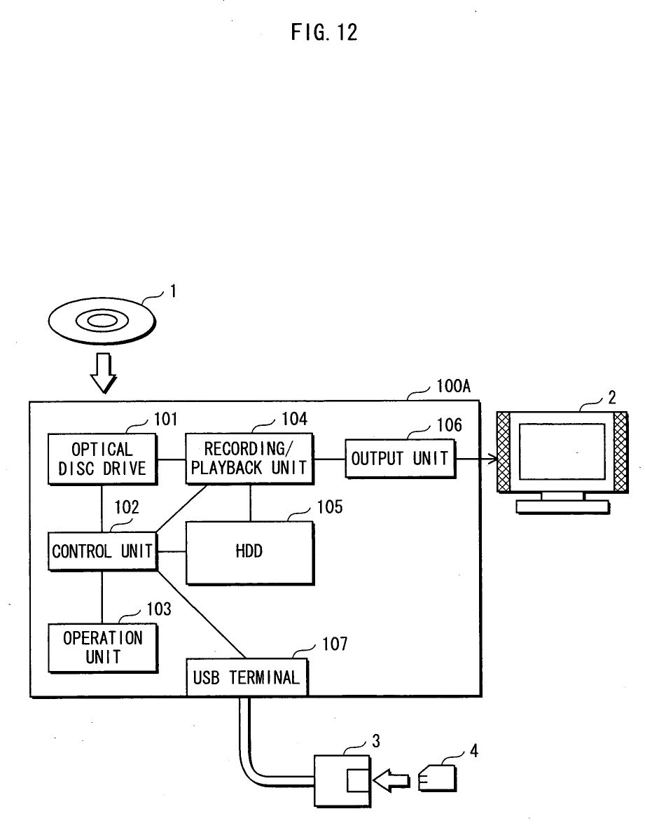

FIG. 12 shows a functional construction of the content recording/playback apparatus according to modification 5.

In FIG. 12, a content recording/playback apparatus 100A has a construction in which a USB (Universal Serial Bus) terminal 107 has been added to the content recording/playback apparatus 100 shown in FIG. 1.

The USB terminal 107 is connected to a reader/writer 3.

The reader/writer 3 is capable of reading/writing data from/to a memory card 4 loaded to the reader/writer 3.

It is assumed here that a speed of reading data from the memory card 4 by the reader/writer 3 is higher than a speed of reading data from the optical disc 1 by the optical disc drive 101.

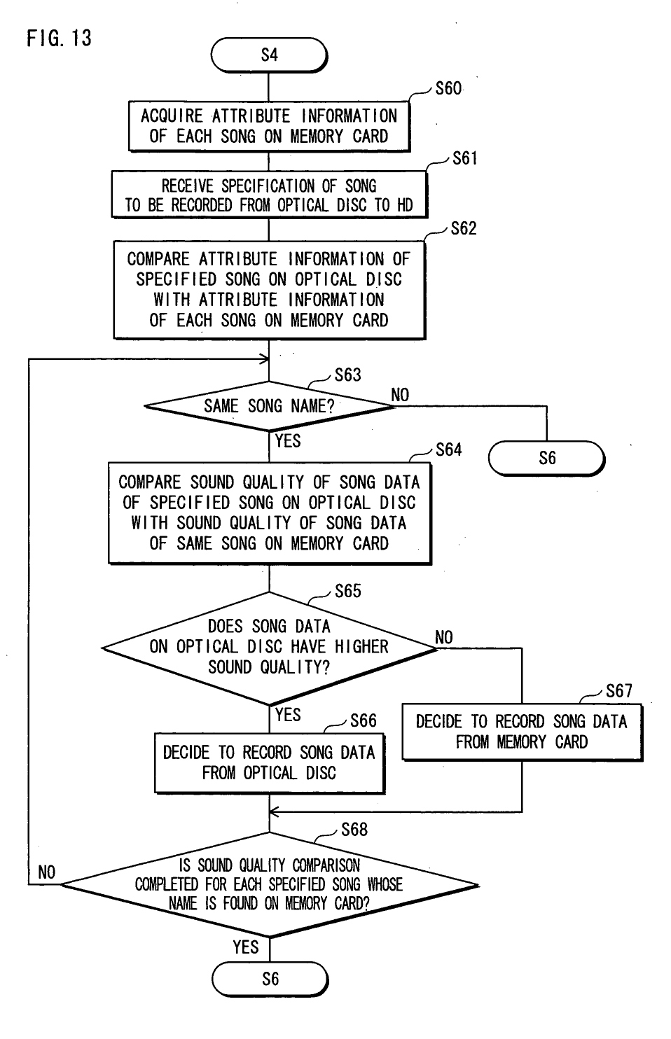

FIG. 13 is a flowchart of an operation of the content recording/playback apparatus 100A according to modification 5.

In this operation, steps S1 to S4 are the same as those shown in FIG. 2, and so their explanation has been omitted here.

The control unit 102 in the content recording/playback apparatus 100A instructs the reader/writer 3 to read attribute information of each song recorded on the memory card 4 (S60).

A GUI screen showing a playlist of the songs recorded on the optical disc 1 is displayed on the display device 2. In this playlist, the user specifies one or more songs to be recorded from the optical disc 1 to the hard disk (S61).

For each specified song, the control unit 102 compares attribute information of the specified song with the attribute information of each song on the memory card 4 (S62).

If the comparison reveals that a song which has the same name as the specified song has been recorded on the memory card 4 (S63:YES), the control unit 102 compares a sound quality of first song data which constitutes the song on the optical disc 1 with a sound quality of song data (hereafter “third song data”) which constitutes the same song on the memory card 4 (S64). The sound quality referred to here includes a recording method and a bit rate.

If the first song data has a higher sound quality than the third song data (S65:YES), the control unit 102 decides to record the first song data to the hard disk (S66). The control unit 102 then proceeds to step S68.

If the first song data has no higher sound quality than the third song data (S65:NO), on the other hand, the control unit 102 decides to record the third song data to the hard disk (S67). The control unit 102 then proceeds to step S68.

If the sound quality comparison has been completed for each specified song whose name is found on the memory card 4 (S68:YES), the control unit 102 proceeds to step S6. Otherwise (S68:NO), the control unit 102 returns to step S63.

<Modification 6>

In modification 5, if the first song data and the third song data are equal in sound quality in step S65, the third song data read by the reader/writer 3 which has a higher data reading rate is selected. However, which of the optical disc drive 101 and the reader/writer 3 has a higher data reading rate may be unknown. Accordingly, the operation of modification 5 may be modified in the following way.

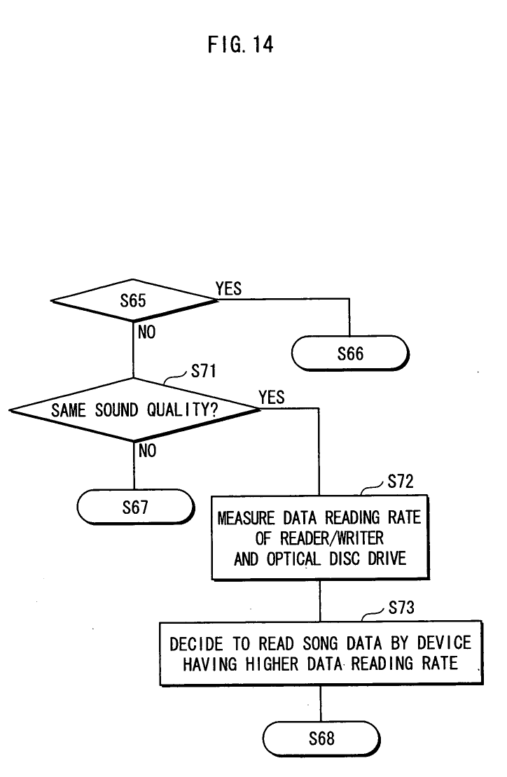

FIG. 14 is a flowchart of an operation of the content recording/playback apparatus 100A according to modification 6.

If the first song data on the optical disc 1 and the third song data on the memory card 4 are equal in sound quality (S71:YES), the control unit 102 measures a data reading rate of each of the reader/writer 3 and the optical disc drive 101 (S72).

The control unit 102 decides to read song data from one of the reader/writer 3 and the optical disc drive 101 that has a higher data reading rate (S73). The control unit 102 then proceeds to step S68.

If the first song data has a lower sound quality than the third song data (S71:NO), the control unit 102 proceeds to step S67.

In the above operation, a data reading rate is used as the judgment criterion in step S73. Alternatively, a recording medium property (e.g. reliability of sector information) may be used as the judgment criterion.

<Modification 7>

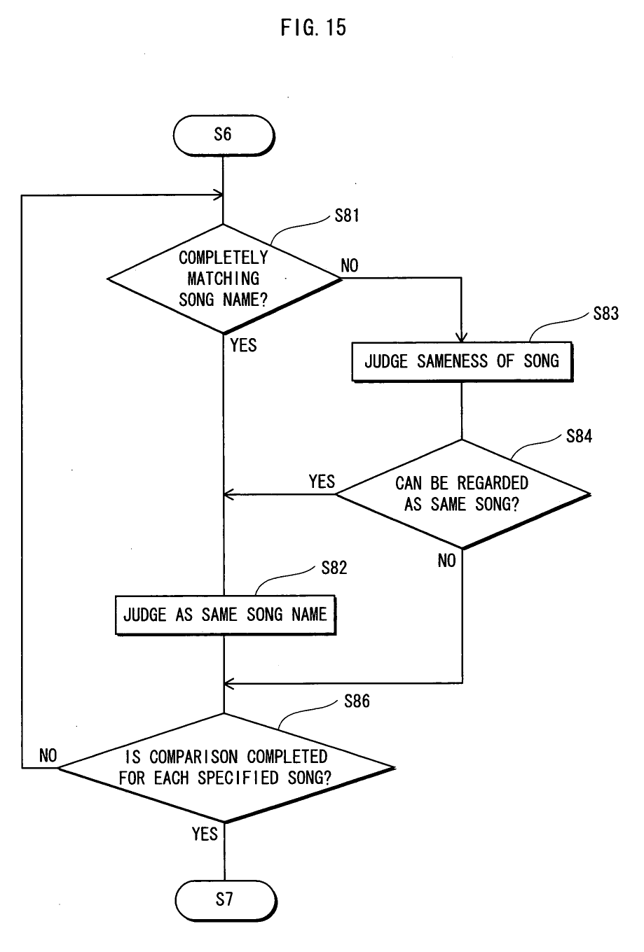

FIG. 15 is a flowchart of an operation of the content recording/playback apparatus 100 according to modification 7.

In this operation, steps S1 to S6 are the same as those shown in FIG. 2, and so their explanation has been omitted here.

If the comparison of the attribute information in step S6 reveals that a name of a song on the hard disk completely matches the name of the specified song (S81:YES), the control unit 102 judges the song as having the same name as the specified song (S82). The control unit 102 then judges whether the name comparison has been completed for each specified song (S86).

If the name comparison has been completed for each specified song (S86:YES), the control unit 102 proceeds to step S7. If not, the control unit 102 returns to step S81.

If the name of the song on the hard disk incompletely matches the name of the specified song (S81:NO), the control unit 102 judges sameness of the two songs (S83).

If the two songs are judged as the same (S84:YES), the control unit 102 proceeds to step S82. If the two songs are judged as different (S84:NO), on the other hand, the control unit 102 proceeds to step S86.

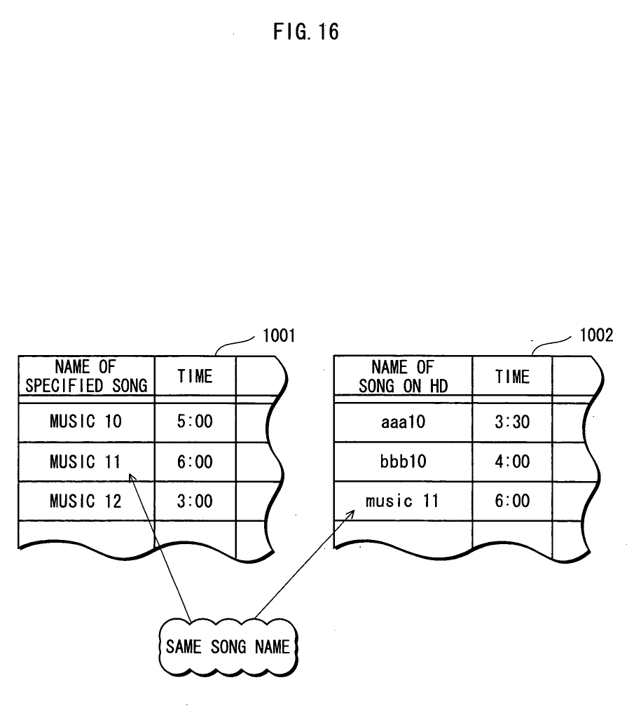

A specific example of this operation is explained below, with reference to FIG. 16.

In FIG. 16, a table 1001 shows part of attribute information of each specified song recorded on the optical disc 1, whereas a table 1002 shows part of attribute information of each song recorded on the hard disk.

For each specified song, the control unit 102 compares attribute information of the specified song with attribute information of each song on the hard disk.

In the example of FIG. 16, though a song with a name “MUSIC 11” written in uppercase alphabets does not exist on the hard disk, a song with a name “music 11” written in lowercase alphabets exists on the hard disk. In such a case, the control unit 102 judges whether the song “music 11” is the same as the song “MUSIC 11”, by comparing other parameters in the attribute information such as a time.

As a result, if the song “music 11” is judged as the same as the song “MUSIC 11”, the control unit 102 judges the song “music 11” as having the same name as the song “MUSIC 11”. The control unit 102 then compares a compression scheme and a bit rate of first song data which constitutes the song “MUSIC 11” on the optical disc 1, with a compression scheme and a bit rate of second song data which constitutes the song “music 11” on the hard disk.

As described above, when a song to be recorded from the optical disc 1 to the hard disk is specified by the user, the content recording/playback apparatus 100 checks whether a song that can be regarded as the same as the specified song has already been recorded on the hard disk. If such a song exists, the content recording/playback apparatus 100 judges whether song data of the song on the optical disc 1 has a higher sound quality than song data of the same song on the hard disk. If the song data on the optical disc 1 has a higher sound quality, the content recording/playback apparatus 100 records the song data on the optical disc 1 to the hard disk to replace the already-recorded song data. If the song data on the optical disc 1 has no higher sound quality, the content recording/playback apparatus 100 does not record the song data on the optical disc 1 to the hard disk. In so doing, higher-quality song data can be recorded on the hard disk without duplicated recording.

<Modification 8>

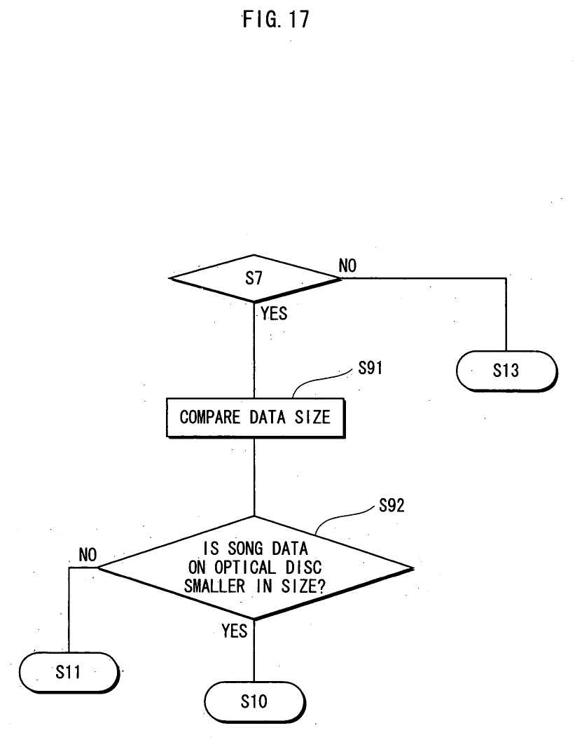

FIG. 17 is a flowchart of an operation of the content recording/playback apparatus 100 according to modification 8.

In this operation, step S1 to S7 are the same as those shown in FIG. 2, and so their explanation has been omitted here.

If the comparison of the attribute information reveals that a song having the same name as the specified song has already been recorded on the hard disk (S7: YES), the control unit 102 compares a size of the first song data which constitutes the song on the optical disc 1 with a size of the second song data which constitutes the same song on the hard disk (S91).

If the first song data is smaller in size than the second song data (S92:YES), the control unit 102 decides to record the first song data to the hard disk to replace the second song data (S10).

If there is no song having the same name as the specified song (S7:NO), the control unit 102 proceeds to step S13.

If the first song data is no smaller in size than the second song data (S92:NO), the control unit 102 decides not to record the first song data to the hard disk (S11).

<Modification 9>

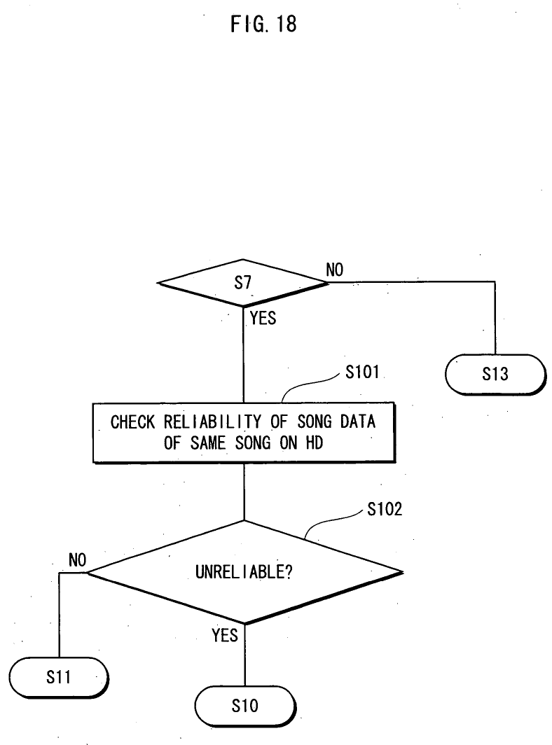

FIG. 18 is a flowchart of an operation of the content recording/playback apparatus 100 according to modification 9.

In this operation, step S1 to S7 are the same as those shown in FIG. 2, and so their explanation has been omitted here.

If the comparison of the attribute information reveals that a song having the same name as the specified song has already been recorded on the hard disk (S7:YES), the control unit 102 judges reliability of second song data which constitutes the same song on the hard disk (S101).

If the second song data is judged to be unreliable (S102:YES), the control unit 102 decides to record first song data which constitutes the song on the optical disc 1, to the hard disk to replace the second song data (S10).

If there is no song which has the same name as the specified song (S7:NO), the control unit 102 proceeds to step S13.

If the second song data is judged to be reliable (S102:NO), the control unit 102 decides not to record the first song data to the hard disk (S11).

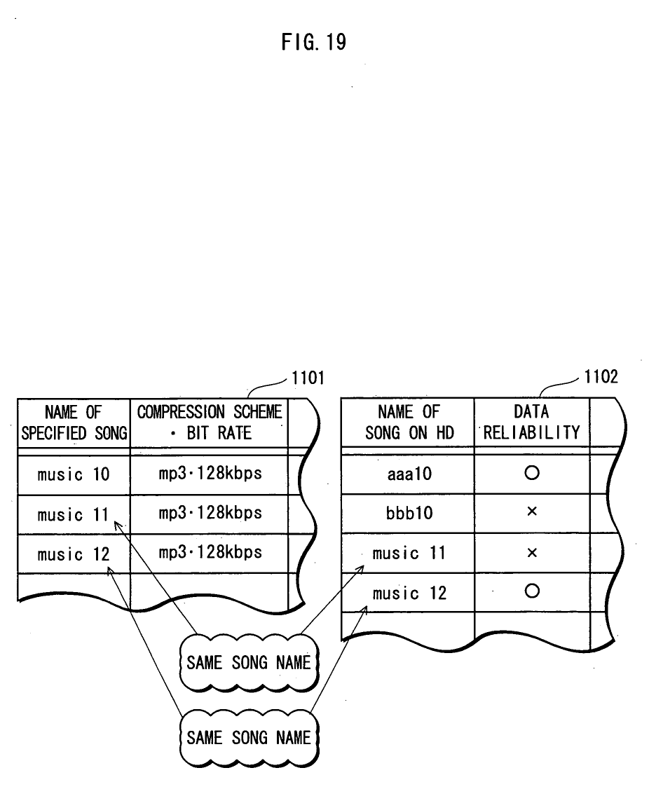

An operation of judging the reliability of content data is explained below, by referring to FIG. 19.

In FIG. 19, a table 1101 shows part of attribute information of each specified song recorded on the optical disc 1, whereas a table 1102 shows part of attribute information of each song recorded on the hard disk.

For each specified song, the control unit 102 compares attribute information of the specified song with attribute information of each song on the hard disk. In the example of FIG. 19, a song “music 11” has already been recorded on the hard disk, so that the control unit 102 checks reliability of song data of the song “music 11” on the hard disk.

Since the song data is unreliable (marked “X” in a data reliability field in the table 1102), the control unit 102 decides to record song data of the song “music 11” on the optical disc 1, to the hard disk. Also, a song “music 12” has already been recorded on the hard disk, so that the control unit 102 checks reliability of song data of the song “music 12” on the hard disk. Since the song data is reliable (marked “◯” in the data reliability field in the table 1102), the control unit 102 decides not to record song data of the song “music 12” on the optical disc 1 to the hard disk.

As described above, when a song to be recorded from the optical disc 1 to the hard disk is specified by the user, the content recording/playback apparatus 100 checks whether the same song has already been recorded on the hard disk. If the same song exists, the content recording/playback apparatus 100 checks reliability of song data of the song on the hard disk. If the song data on the hard disk is unreliable, the content recording/playback apparatus 100 records song data of the song on the optical disc 1 to the hard disk to replace the already-recorded song data. If the song data on the hard disk is reliable, the content recording/playback apparatus 100 does not record the song data on the optical disc 1 to the hard disk. In this way, the reliability of song data on the hard disk can be improved.

Here, three examples of setting data reliability are given below.

(1) Before receiving a specification of a song to be recorded from the optical disc 1 to the hard disk, song data recorded on the hard disk is played back to check if data continuity is lost due to jumpiness and the like. A result of the check is written to the data reliability field in the table 1102.

(2) When receiving a specification of a song to be recorded from the optical disc 1 to the hard disk, a check is made as to whether information included in a header of binary data of song data recorded on the hard disk is incorrect (e.g. the header information does not comply with AAC despite that the song data is AAC data). A result of the check is written in the data reliability field in the table 1102.

(3) When receiving a specification of a song to be recorded from the optical disc 1 to the hard disk, a check is made as to whether a physical position of song data on the hard disk is incorrect (e.g. a sector where the song data is stored is defective according to TOC information in the hard disk). A result of the check is written in the data reliability field in the table 1102.

<Modification 10>

When recording song data of a song to the hard disk to replace existing song data of the same song, a playlist corresponding to the existing song data may be updated so as to correspond to the newly-recorded song data.

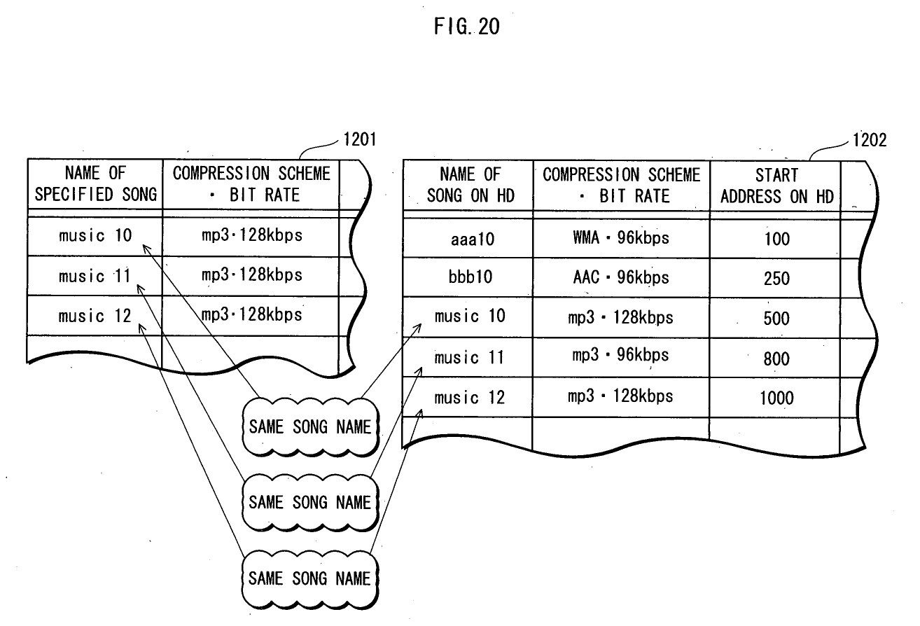

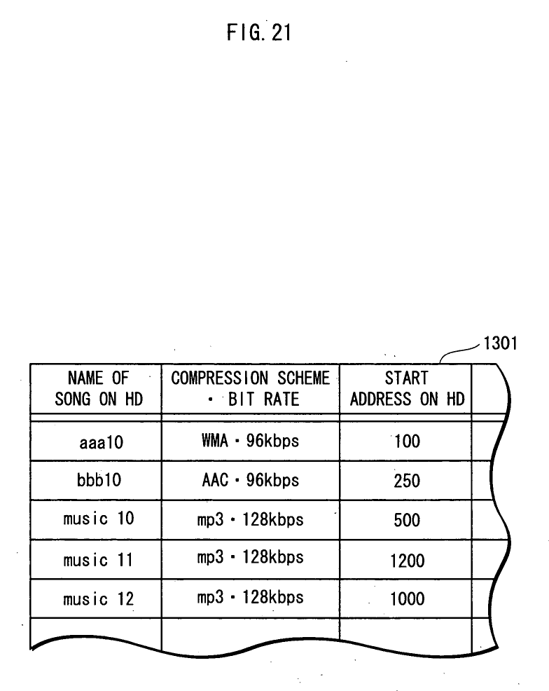

A specific example of this playlist update operation is explained below, with reference to FIGS. 20 and 21.

In FIG. 20, a table 1201 shows part of attribute information of each specified song recorded on the optical disc 1, whereas a table 1202 shows part of attribute information of each song recorded on the hard disk.

In FIG. 21, a table 1301 shows part of attribute information of each song on the hard disk after a song has newly been recorded from the optical disc 1 to the hard disk.

For each specified song, the control unit 102 compares attribute information of the specified song with attribute information of each song on the hard disk. As a result, the names of songs “music 10”, “music 11”, and “music 12” are found on the hard disk. Of these songs, song data of the song “music 11” on the optical disc 1 has a higher sound quality than song data of the same song “music 11” on the hard disk, so that this song data is recorded to the hard disk to replace the existing song data.

This newly-recorded song data is written at a different position of the hard disk from the existing song data. Accordingly, a start address field in the attribute information of the song “music 11” is changed from “800” to “1200”, as shown in FIG. 21.

<Modification 11>

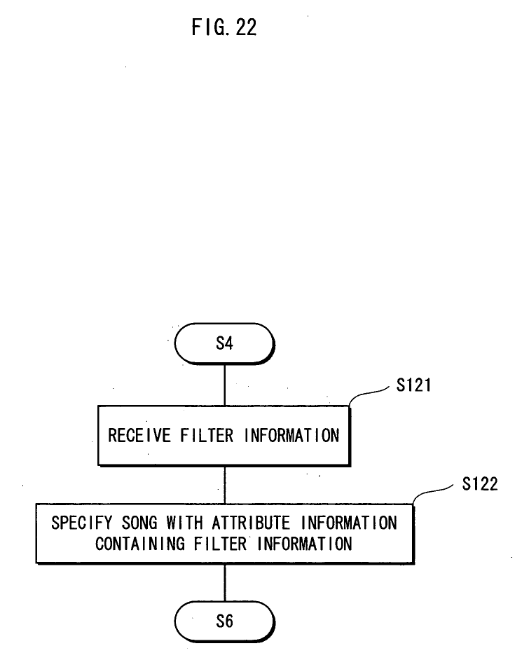

FIG. 22 is a flowchart of an operation of the content recording/playback apparatus 100 according to modification 11.

In this operation, steps S1 to S4 are the same as those shown in FIG. 2, and so their explanation has been omitted here.

First, to specify a song to be recorded from the optical disc 1 to the hard disk, the user designates filter information for extracting the song recorded on the optical disc 1 based on attribute information, by operating the operation buttons in the operation unit 103. The control unit 102 receives the designation (S121).

The control unit 102 specifies each song whose attribute information contains the filter information, as a song to be recorded (S122). The control unit 102 then proceeds to step S6.

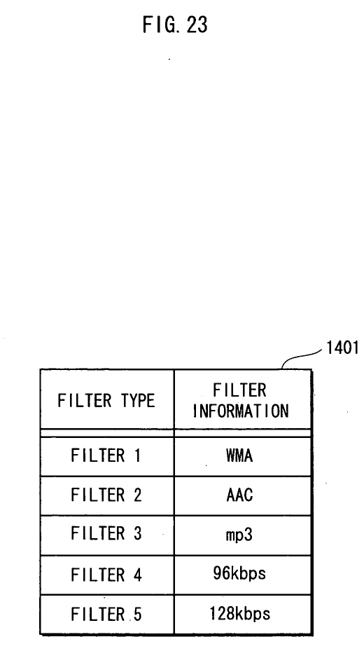

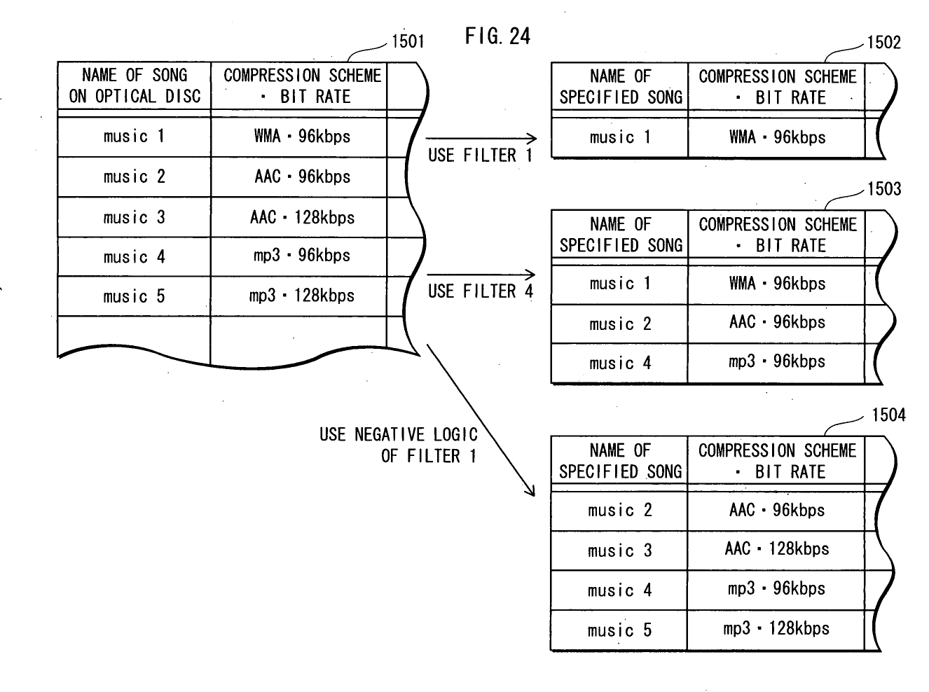

A specific example of content selection using filter information is explained below, with reference to FIGS. 23 and 24.

In FIG. 23, a table 1401 shows example filter information. In FIG. 24, a table 1501 shows part of attribute information of each song recorded on the optical disc 1, whereas each of tables 1502, 1503, and 1504 shows part of attribute information of each song extracted using corresponding filter information.

For example, when a filter 1 is selected in the table 1401, a song “music 1” whose attribute information shows “WMA” is specified as a song to be recorded, as shown in the table 1502.

When a filter 4 is selected in the table 1401, songs “music 1”, “music 2”, and “music 4” whose attribute information shows “96 kbps” are specified as songs to be recorded, as shown in the table 1503.

When a negative logic of the filter 1 is selected in the table 1401, songs “music 2”, “music 3”, “music 4”, and “music 5” whose attribute information does not show “WMA” are specified as songs to be recorded, as shown in the table 1504.

Here, the filters may be used in combination, such as combining a negative logic of a filter 2 with a logical product of the filter 4.

Also, filter information may indicate a title, an artist, a data size, a recording date and time, and a recording day of week. Filter information may also indicate a lower-limit data size, an upper-limit data size, or a data size range. Filter information may further indicate an earliest-limit recording date and time, a latest-limit recording date and time, or a recording date and time range.

<Other Modifications>

Though the present invention has been described by way of the above embodiment and modifications, it should be obvious that the present invention is not limited to the above. Example modifications are given below.

(1) The above embodiment describes the case where a song on the optical disc 1 loaded to the optical disc drive 101 is subjected to recording, but the recording target may instead be a song on other recording media such as a memory card, or a song that can be acquired via an internet. Also, a recording medium to which the song is to be recorded may be a portable optical disc, memory card, MD (Mini Disc), flexible disk, and the like, instead of the hard disk in the content recording/playback apparatus.

(2) The above embodiment describes the case where the recording target is music, but the recording target may instead be content such as a game or a TV program including photographs, moving images, and sounds. In the case of images, for example, higher-quality content is recorded to the hard disk through comparison of information about a quality of image data such as a compression scheme, a bit rate, and a frame size.

(3) The above embodiment describes the case where the recording target is a user-specified song, a song that belongs to a group corresponding to a selected playlist, or a song corresponding to user-input character information, but the recording target is not limited to such. As one example, the recording target may be a song except a user-specified song.

(4 ) Programs that cause a computer or the like to execute the processing steps of the content recording/playback apparatus 100 or 100A (e.g. the steps shown in FIGS. 2, 5, 6, 10, 11, 13, 14, 15, 17, 18, and 22) may be distributed having been recorded onto a storage medium or by being transmitted via a communication path. Examples of such a storage medium are a memory card, an optical disc, a flexible disk, and a ROM. The programs may then be installed into the computer or the like. By executing the installed programs, the computer or the like can achieve the functions described in the above embodiment and modifications.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A content recording apparatus comprising:
a first acquisition unit operable to acquire attribute information of first content which is to be recorded to a recording medium;
a second acquisition unit operable to acquire attribute information of second content which has been recorded on the recording medium, the attribute information of each of the first content and the second content including ID information of the content and information about a quality of the content;
a comparison unit operable to compare the attribute information of the first content with the attribute information of the second content; and
a decision unit operable to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

2. The content recording apparatus of claim 1,
wherein the attribute information further includes information showing a data size of the content,
the comparison unit compares a data size of the first content with a data size of the second content, when the ID information of the first content is same as the ID information of the second content and the quality of the first content is equal to the quality of the second content, and
the decision unit makes, based on the comparison, the second decision if the ID information of the first content is same as the ID information of the second content, the quality of the first content is equal to the quality of the second content, and the data size of the first content is smaller than the data size of the second content, and the third decision if the ID information of the first content is same as the ID information of the second content, the quality of the first content is equal to the quality of the second content, and the data size of the first content is no smaller than the data size of the second content.

3. The content recording apparatus of claim 1 further comprising
a playlist generation unit operable to generate a playlist associated with the first content when the decision unit makes the first decision or the second decision, and a playlist associated with the second content when the decision unit makes the third decision.

4. The content recording apparatus of claim 3 further comprising:
a storage unit operable to store a playlist in correspondence with group information showing a group to which content associated with the playlist belongs; and
a reception unit operable to receive an indication of the playlist stored in the storage unit,
wherein the first acquisition unit acquires the attribute information of the first content based on the group information corresponding to the indicated playlist, and
the playlist generation unit updates the indicated playlist to thereby generate the playlist associated with the first content, when the decision unit makes the first decision or the second decision.

5. The content recording apparatus of claim 1 further comprising
a reception unit operable to receive an input of character information,
wherein the first acquisition unit acquires the attribute information of the first content that relates to the received character information.

6. The content recording apparatus of claim 1,
wherein the first content is music including audio data, and
the content recording apparatus further comprises:
an obtainment unit operable to obtain the first content when the decision unit makes the first decision or the second decision;
an estimation unit operable to analyze the audio data in the first content and estimate a genre of the first content; and
a recording unit operable to record the first content to the recording medium, in correspondence with the estimated genre.

7. The content recording apparatus of claim 1,
wherein the attribute information includes, as the ID information, title information showing a name of the content, and
the decision unit makes (a) the first decision if title information of the first content completely differs from title information of the second content, (b) the second decision if the title information of the first content is partially or completely same as the title information of the second content and the quality of the first content is higher than the quality of the second content, and (c) the third decision if the title information of the first content is partially or completely same as the title information of the second content and the quality of the first content is no higher than the quality of the second content.

8. The content recording apparatus of claim 1 further comprising
a check unit operable to check whether data of the second content is indefective, when the ID information of the first content is same as the ID information of the second content,
wherein the decision unit makes the second decision if a result of the check is negative.

9. The content recording apparatus of claim 8,
wherein the check unit checks whether information included in a header of binary data of the second content is correct, when the ID information of the first content is same as the ID information of the second content.

10. The content recording apparatus of claim 1 further comprising
a check unit operable to check whether a physical address of the second content on the recording medium is correct, when the ID information of the first content is same as the ID information of the second content,
wherein the decision unit makes the second decision if a result of the check is negative.

11. The content recording apparatus of claim 1 further comprising
a reception unit operable to receive an indication of filter information for selecting the first content, the filter information showing a part of the attribute information of the first content,
wherein the first acquisition unit acquires the attribute information of the first content, the attribute information of the first content including the part shown by the indicated filter information.

12. The content recording apparatus of claim 1 further comprising
a reception unit operable to receive an indication of filter information for selecting the first content, the filter information showing no part of the attribute information of the first content,
wherein the first acquisition unit acquires the attribute information of the first content, the attribute information of the first content including no part shown by the indicated filter information.

13. A content recording apparatus comprising:
a reception unit operable to receive a request to record first content which has been recorded on a first recording medium, to a second recording medium;
a first acquisition unit operable to acquire attribute information of the first content;
a second acquisition unit operable to acquire attribute information of second content which has been recorded on a third recording medium, the attribute information of each of the first content and the second content including ID information of the content and information about a quality of the content;
a comparison unit operable to compare the attribute information of the first content with the attribute information of the second content; and
a decision unit operable to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.

14. The content recording apparatus of claim 13,
wherein the comparison unit further compares a speed of reading the first content from the first recording medium with a speed of reading the second content from the third recording medium, when the ID information of the first content is same as the ID information of the second content and the quality of the first content is equal to the quality of the second content, and
the decision unit makes, based on the comparison, (a) the first decision if the ID information of the first content is same as the ID information of the second content, the quality of the first content is equal to the quality of the second content, and the speed of reading the first content is higher than the speed of reading the second content, and (b) the second decision if the ID information of the first content is same as the ID information of the second content, the quality of the first content is equal to the quality of the second content, and the speed of reading the first content is no higher than the speed of reading the second content.

15. A content recording method for use in a content recording apparatus, comprising steps of:
acquiring attribute information of first content which is to be recorded to a recording medium;
acquiring attribute information of second content which has been recorded on the recording medium, the attribute information of each of the first content and the second content including ID information of the content and information about a quality of the content;
comparing the attribute information of the first content with the attribute information of the second content;
making, based on the comparison, a first decision to record the first content to the recording medium if ID information of the first content differs from ID information of the second content;
making, based on the comparison, a second decision to record the first content to the recording medium to replace the second content if the ID information of the first content is same as the ID information of the second content and a quality of the first content is higher than a quality of the second content; and
making, based on the comparison, a third decision not to record the first content to the recording medium if the ID information of the first content is same as the ID information of the second content and the quality of the first content is no higher than the quality of the second content.

16. A computer program used in a computer for deciding whether to record content to a recording medium, comprising:
program code operable to cause the computer to acquire attribute information of first content which is to be recorded to the recording medium;
program code operable to cause the computer to acquire attribute information of second content which has been recorded on the recording medium, the attribute information of each of the first content and the second content including ID information of the content and information about a quality of the content;
program code operable to cause the computer to compare the attribute information of the first content with the attribute information of the second content; and
program code operable to cause the computer to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

17. A storage medium storing a computer program used in a computer for deciding whether to record content to a recording medium, the computer program comprising:
program code operable to cause the computer to acquire attribute information of first content which is to be recorded to the recording medium;
program code operable to cause the computer to acquire attribute information of second content which has been recorded on the recording medium, the attribute information of each of the first content and the second content including ID information of the content and information about a quality of the content;
program code operable to cause the computer to compare the attribute information of the first content with the attribute information of the second content; and
program code operable to cause the computer to make, based on the comparison, (a) a first decision to record the first content to the recording medium if ID information of the first content differs from ID information of the second content, (b) a second decision to record the first content to the recording medium to replace the second content if the ID information of the first content is same as the ID information of the second content and a quality of the first content is higher than a quality of the second content, and (c) a third decision not to record the first content to the recording medium if the ID information of the first content is same as the ID information of the second content and the quality of the first content is no higher than the quality of the second content.

18. A content recording method for use in a content recording apparatus, comprising steps of:
receiving a request to record first content which has been recorded on a first recording medium, to a second recording medium;
acquiring attribute information of the first content;
acquiring attribute information of second content which has been recorded on a third recording medium, the attribute information of each of the first content and the second content including ID information of the content and information about a quality of the content;
comparing the attribute information of the first content with the attribute information of the second content;
making, based on the comparison, a first decision to record the first content to the second recording medium if ID information of the first content differs from ID information of the second content or if the ID information of the first content is same as the ID information of the second content and a quality of the first content is higher than a quality of the second content; and
making, based on the comparison, a second decision to record the second content to the second recording medium if the ID information of the first content is same as the ID information of the second content and the quality of the first content is no higher than the quality of the second content.

19. A computer program used in a computer for recording content to a recording medium, comprising:
program code operable to cause the computer to receive a request to record first content which has been recorded on a first recording medium, to a second recording medium;
program code operable to cause the computer to acquire attribute information of the first content;
program code operable to cause the computer to acquire attribute information of second content which has been recorded on a third recording medium, the attribute information of each of the first content and the second content including ID information of the content and information about a quality of the content;
program code operable to cause the computer to compare the attribute information of the first content with the attribute information of the second content; and
program code operable to cause the computer to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.

20. A storage medium storing a computer program used in a computer for recording content to a recording medium, the computer program comprising:
program code operable to cause the computer to receive a request to record first content which has been recorded on a first recording medium, to a second recording medium;
program code operable to cause the computer to acquire attribute information of the first content;
program code operable to cause the computer to acquire attribute information of second content which has been recorded on a third recording medium, the attribute information of each of the first content and the second content including ID information of the content and information about a quality of the content;
program code operable to cause the computer to compare the attribute information of the first content with the attribute information of the second content; and
program code operable to cause the computer to make, based on the comparison, (a) a first decision to record the first content to the second recording medium if ID information of the first content differs from ID information of the second content or if the ID information of the first content is same as the ID information of the second content and a quality of the first content is higher than a quality of the second content, and (b) a second decision to record the second content to the second recording medium if the ID information of the first content is same as the ID information of the second content and the quality of the first content is no higher than the quality of the second content.
